(19) United States
(12) Patent Application Publication
(10) Pub. No.: US 2005/0088341 A1
(43) Pub. Date: Apr. 28, 2005

(54) PRINTED MONOPOLE ANTENNA

(76) Inventor: Shih-Tsai Yang, Shenkeng Township (TW)

Correspondence Address: Yi-Wen Tseng, 509 ROOSEVELT BLVD. #D306, FALLS CHURCH, VA, 22044, US

(21) Appl. No.: 10/692,888

(22) Filed: Oct. 27, 2003

(51) Int. Cl. H01Q 1/38

(52) U.S. Cl. 343/700 MS; 343/702

(57) ABSTRACT

A printed monopole antenna, having a spiral copper foil formed on a substrate of a printed circuit board is disclosed. The copper foil has two parallel conductive arms in communication with each other by at least another conductive arm extending across these two parallel conductive arms. The first one of the parallel conductive arms has one end reaching a lower edge of the substrate to serve as a signal feed point. The copper foil further has an adjust arm perpendicularly extending from an elongate edge of the second one of the parallel conductive arms towards the first one of the parallel conductive arm. The formation of the adjust arm expands the bandwidth of radio frequency of the antenna. Further, by changing the length of the adjust arm, the overall bandwidth of the antenna can be adjusted as required.

### BACKGROUND OF THE INVENTION

The present invention relates to a printed monopole antenna, and more particular, to a built-in antenna module applied to wireless devices of which operation frequency is the ISM (industry, science and medicine frequency) frequency.

The ISM frequency at 2.4 GHz is a broadly applied wireless frequency. Currently, the cordless phone, wireless local area network, wireless audio-video (AV) sender and wireless mouse all operate with such frequency. As the lighter, thinner and smaller wireless communication devices are continuously developed, the small built-in antenna which avoids affecting the integration of the devices has become more and more popular.

To reduce the occupied space, planar antenna has been adapted as the small built-in antenna. The commonly used planar antenna modules include low temperature co-fired ceramics (LTCC) disclosed in U.S. Pat. No. 5,859, 614. The low temperature co-fired ceramic antennal use ceramic material for fabricating substrate of a printed circuit board. The radiator is embedded into a multi-layered substrate in a sintering furnace at 850 to 900 degree Celsius, such that an integrated ceramic device is formed by sintering. The material characteristics of ceramic is very similar to those of silicon, such that ceramic is suitable to connect with integrated circuit. The ceramic substrate can be fabricated with very small size. However, when the low temperature co-fired ceramic device is formed by sintering process at a temperature within 900° C., it is problematic for its variable contraction. If stack process is used to replace the sintering process, the electric characteristics are easily changed to reduce the yield. Further, the cost is also increased.

Another type of antenna device, the printed square spiral antenna has also been disclosed in U.S. Pat. No. 6,166,694. As shown in FIG. 1, the printed square spiral antenna includes a planar antenna formed by square spiral copper foil 31 formed on a printed circuit board 3. The antenna is a dual-band antenna which emphasizes the balance between these two bands. In the ISM frequency application, the voltage standing wave ratio (VSWR) is 2.5:1 and the bandwidth is 110 MHz. The ideal voltage standing wave ratio is 1:1. A voltage standing wave ratio over 2:1 does not provide practical applicability. However, for such antenna device, if the voltage standing wave ratio is kept lower than 2:1, the effective bandwidth is narrower than 100 MHz. Therefore, this type of product cannot be used for devices with wider bandwidth such as wireless mouse.

### BRIEF SUMMARY OF THE INVENTION

The present invention provides a printed monopole antenna applicable for ISM frequency. The printed monopole antenna is fabricated with minimal cost, and the bandwidth of the printed monopole antenna can be adjusted according to specific requirement.

The monopole antenna provided by the present invention comprises a spiral copper foil formed on a substrate of a printed circuit board. The copper foil comprises two parallel conductive arms in communication with each other by at least another conductive arm extending across these two parallel conductive arms. The first one of the parallel conductive arms has one end reaching a lower edge of the substrate to serve as a signal feed point. The copper foil further comprises an adjust arm perpendicularly extending from an elongate edge of the second one of the parallel conductive arms towards the first one of the parallel conductive arm. The formation of the adjust arm expands the bandwidth of radio frequency of the antenna. Further, by changing the length of the adjust arm, the overall bandwidth of the antenna can be adjusted as required.

### BRIEF DESCRIPTION OF THE DRAWINGS

These, as well as other features of the present invention, will become apparent upon reference to the drawings wherein:

FIG. 1 shows a conventional printed dual-pole antenna;

FIG. 2 shows a printed monopole antenna applied to a wireless communication device;

FIG. 3 shows a top view of the printed monopole antenna; and

FIG. 4 shows the graph of voltage standing wave ratio of the printed monopole antenna applied to ISM frequency.

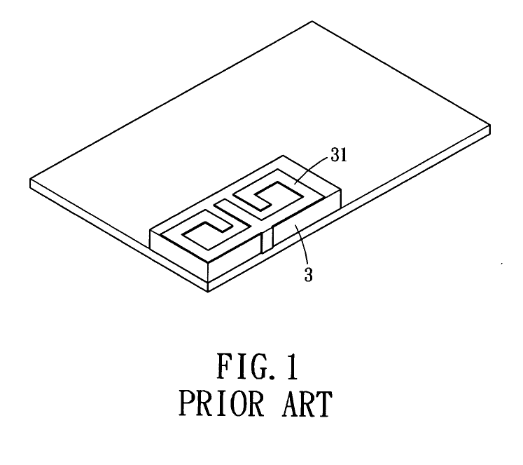

### DETAILED DESCRIPTION OF THE INVENTION

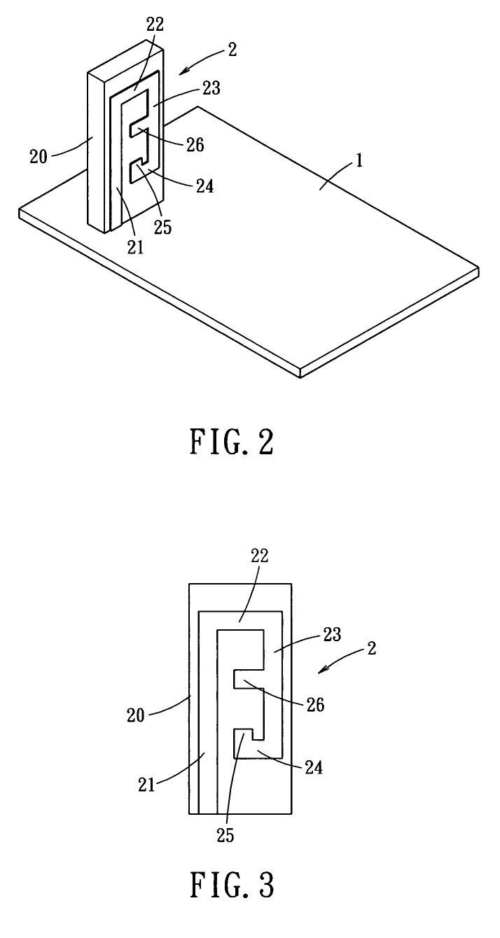

FIG. 2 shows a printed monopole antenna provided by the present invention. As shown, the antenna module 2 is vertically disposed on a printed circuit board 1 of a wireless communication device. The antenna module 2 includes a substrate 20, preferably a rectangular substrate, on which a copper foil is printed. Referring to the enlarged view as shown in FIG. 3, the copper foil comprises five conductive arms 21 to 25. As shown, a first conductive arm 21 extending along an elongate edge of the substrate 20 has a first end reaches a lower edge of the substrate 20 to serve as a signal feed point and a second end extending near an upper edge of the substrate 20. The second end of the first conductive arm 21 is bent perpendicularly to form a second conductive arm 22 extending perpendicular to the elongate edge of the substrate 20. The terminus of the second conductive arm 22 is then perpendicularly bent to form a third conductive arm 23 which extend parallel to the first conductive arm 21. In this embodiment, the third conductive arm 23 is shorter than the first conductive arm 21. However, it will be appreciated that length of the third conductive arm 23 can be adjusted according to specific requirement. The terminus of the third conductive arm 23 is perpendicularly bent to form the fourth conductive arm 24 extends towards the first conductive arm 21. Before reaching the first conductive arm 21, the terminus of the fourth conductive arm 24 is perpendicularly bent to form a fifth conductive arm 25. As shown, the fifth conductive arm 25 is much shorter than the third conductive arm 23. In addition to the first to fifth conductive arms 21 to 25, an adjust arm 26 is formed to extend perpendicularly from an elongate length of the third conductive arm 23 towards the first conductive arm 21. The formation of the adjust arm 26 expands the overall radio frequency bandwidth of the antenna module 2. The length of the adjust arm 26 can be varied to adjust the bandwidth. The longer the adjust arm 26 is, the wider the bandwidth is.

The total length of the first to fifth conductive arms 21 to 25 is one quarter of the radio frequency of the antenna module 2. Such length is dependent on the thickness of the substrate 20, the dielectric constant and the rate of expansion of the spiral. The radiator of the antenna module 2 is constructed by the spiral slots formed by the conductive arms 21 to 26 on the substrate 20.

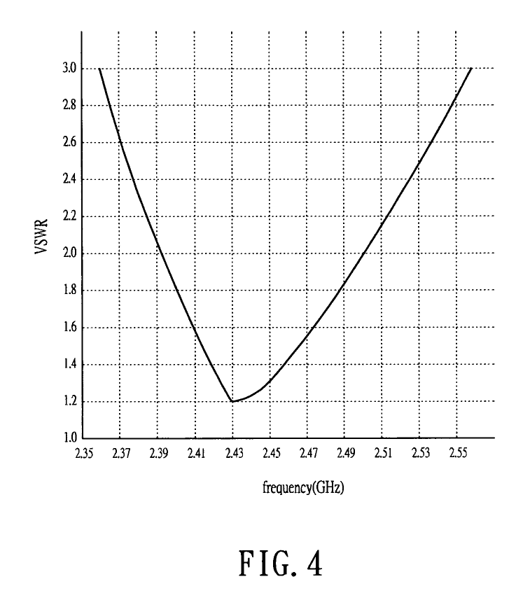

FIG. 4 is a graph showing the test results of applying the antenna module 2 to ISM frequency (that is, 2.4 GHz). As shown, the central frequency of the antenna module 2 is 2.43 GHz, and the high and low frequencies are 2.5 GHz and 2.39 GHz, respectively, when the voltage standing wave ratio is 2:1. That is, the bandwidth is about 110 MHz. Compared to the design disclosed in U.S. Pat. No. 6,166,694, the present invention provides the same bandwidth (110 MHz) with an allowed voltage standing wave ratio.

This disclosure provides exemplary embodiments of the present invention. The scope of this disclosure is not limited by these exemplary embodiments. Numerous variations, whether explicitly provided for by the specification or implied by the specification, such as variations in shape, structure, dimension, type of material or manufacturing process may be implemented by one of skill in the art in view of this disclosure.

1. A printed monopole antenna applied to a wireless communication device, comprising a spiral copper foil formed on a substrate, wherein the copper foil includes a first conductive arms extending along an elongate length of the substrate has a first end reaching an edge of the substrate to serve as a feed point, a third conductive arm parallel to the first conductive arm, and an adjust arm protruding perpendicularly from an elongate length of the third conductive arm towards the first conductive arm.

2. The antenna according to claim 1, wherein the substrate is rectangular.

3. The antenna according to claim 1, wherein the copper foil further comprises a second conductive arm extending perpendicular from the a second end of the first conductive arm to a first end of the third conductive arm, a fourth conductive arm extending perpendicularly from a second end of the third conductive arm towards the first conductive arm, and a fifth conductive arm extending perpendicularly from a terminus of the fourth conductive arm towards the adjust arm.

4. The antenna according to claim 1, wherein the total length of the copper foil is one quarter of the wavelength of an operating radio frequency of the antenna.

5. The antenna according to claim 1, wherein the length of the adjust arm is adjustable to change bandwidth of an operation radio frequency of the antenna.
